(19) United States
(12) Patent Application Publication
(10) Pub. No.: US 2026/0145433 A1
(43) Pub. Date: May 28, 2026

(54) LIQUID EJECTING APPARATUS

(71) Applicant: SEIKO EPSON CORPORATION, Tokyo (JP)

(72) Inventors: Tomoya KURASHINA, SHIOJIRI-SHI (JP); Yuichi ARUGA, OKAYA-SHI (JP)

(21) Appl. No.: 19/394,303

(22) Filed: Nov. 19, 2025

(30) Foreign Application Priority Data
Nov. 22, 2024 (JP) 2024-204120

(51) Int. Cl. B41J 2/165; B41J 11/00; B41J 11/06; B41J 29/17; G01S 17/04

(52) U.S. Cl. CPC B41J 2/16511; B41J 11/0095; B41J 11/06; B41J 29/17; G01S 17/04

(57) ABSTRACT

A liquid ejecting apparatus includes a liquid ejecting head, a cap configured to face a liquid ejecting surface of the liquid ejecting head, a shutter configured to be displaceable to a blocking position at which the shutter covers the cap and an open position at which the shutter exposes the cap, and a support located at least upstream or downstream of the shutter in a medium conveyance direction at a position where a medium faces the liquid ejecting head, the support configured to support the medium along with the shutter located at the blocking position. An opening is formed between the shutter at the blocking position and the support, and a wall rising in a direction from a base toward a tip of the cap is provided between the opening and the cap in the medium conveyance direction.

The present application is based on, and claims priority from JP Application Serial Number 2024-204120, filed Nov. 22, 2024, the disclosure of which is hereby incorporated by reference herein in its entirety.

### BACKGROUND

### 1. Technical Field

The present disclosure relates to a liquid ejecting apparatus that ejects liquid onto a medium.

2. Related Art

A recording apparatus described in JP-A-2024-142689 includes a liquid ejecting head, caps that cover a head surface of the liquid ejecting head, and a shutter that is disposed above the caps and is displaceable to a blocking position and an open position.

JP-A-2024-142689 is an example of the related art.

In the recording apparatus described in JP-A-2024-142689, paper dust enters in some cases the space below the shutter at the blocking position. When the paper dust adheres to the caps, the adhesion between the caps and the head surface decreases, which may lead to maintenance failure, and may hence lower the recording quality.

### SUMMARY

A liquid ejecting apparatus according to an aspect of the present disclosure includes: a liquid ejecting head configured to perform recording by ejecting liquid onto a medium; a cap configured to face a liquid ejecting surface of the liquid ejecting head; a shutter configured to be displaceable to a blocking position at which the shutter covers the cap and an open position at which the shutter exposes the cap, the shutter at the blocking position configured to support the medium passing through a position where the medium faces the liquid ejecting head; and a support located at least upstream or downstream of the shutter in a medium conveyance direction at a position where the medium faces the liquid ejecting head, the support configured to support the medium along with the shutter located at the blocking position, an opening is formed between the shutter located at the blocking position and the support, and a wall rising in a first direction that is a direction from a base toward a tip of the cap is provided between the opening and the cap in the medium conveyance direction.

### BRIEF DESCRIPTION OF THE DRAWINGS

FIG. 1 shows an entire medium conveyance path of a printer.

FIG. 2 shows a drive mechanism that raises and lowers a line head.

FIG. 3 shows the operation of a wiper.

FIG. 4 shows the positional relationship between an edge detector and a medium in edge detection.

FIG. 5 is a perspective view of the line head viewed from below.

FIG. 6 is a plan view of head surfaces.

FIG. 7A shows a displacement mechanism that displaces movable rollers with the line head located at a recording position.

FIG. 7B shows the displacement mechanism that displaces movable rollers with the line head located at a position between the recording position and a wiping position.

FIG. 7C shows the displacement mechanism that displaces movable rollers with the line head located at the wiping position.

FIG. 8 is a perspective view of a cap unit.

FIG. 9 is a perspective view of a head facing portion.

FIG. 10 is an exploded perspective view of a crank mechanism.

FIG. 11A is a side view of the shutter in a state in which the shutter is at a blocking position.

FIG. 11B is a side view of the shutter moving halfway from the blocking position to an open position.

FIG. 11C is a side view of the shutter in a state in which the shutter is at the open position and the line head is separate from caps.

FIG. 11D is a side view of the shutter in a state in which the shutter is at the open position and the line head has advanced to the caps.

FIG. 11E is a side view of the shutter moving halfway from the open position to the blocking position.

FIG. 12 is a partially enlarged perspective view of the head facing portion.

FIG. 13 is a cross-sectional view of the head facing portion and the caps.

FIG. 14 is a perspective view of the caps.

FIG. 15 is a cross-sectional view of the head facing portion and the caps and shows another embodiment of a wall.

FIG. 16 is a cross-sectional view of the head facing portion and the caps and shows another embodiment of the wall.

### DESCRIPTION OF EMBODIMENTS

The present disclosure will be schematically described below.

A liquid ejecting apparatus according to a first aspect includes: a liquid ejecting head configured to perform recording by ejecting liquid onto a medium; a cap configured to face a liquid ejecting surface of the liquid ejecting head; a shutter configured to be displaceable to a blocking position at which the shutter covers the cap and an open position at which the shutter exposes the cap, the shutter at the blocking position configured to support the medium passing through a position where the medium faces the liquid ejecting head; and a support located at least upstream or downstream of the shutter in a medium conveyance direction at a position where the medium faces the liquid ejecting head, the support configured to support the medium along with the shutter located at the blocking position, an opening is formed between the shutter located at the blocking position and the support, and a wall rising in a first direction that is a direction from a base toward a tip of the cap is provided between the opening and the cap in the medium conveyance direction.

According to the present aspect, in which the wall rising in the first direction, which is the direction from the base to the tip of the cap, is provided between the opening and the cap in the medium conveyance direction, even when paper dust enters the liquid ejecting head via the opening, the wall can suppress adhesion of the paper dust to the cap.

In a second aspect according to the first aspect, the opening is formed between an upstream end of the shutter in the medium conveyance direction and the support located upstream of the shutter in the medium conveyance direction.

In the configuration in which the opening is formed between the upstream end of the shutter in the medium conveyance direction and the support, when the medium is conveyed downstream in the medium conveyance direction, paper dust tends to enter the liquid ejecting head via the opening, and the paper dust tends to adhere to the cap. The effect and advantage of the first aspect described above can, however, suppress the adhesion of the paper dust to the cap.

In a third aspect according to the second aspect, the liquid ejecting apparatus further includes: at least one contact member integrated with the liquid ejecting head and configured to come into contact with the medium conveyed at a position where the medium faces the liquid ejecting surface; and a holder configured to hold the contact member, the holder is located upstream of the liquid ejecting surface in the medium conveyance direction, the liquid ejecting head is displaceable to a recording position at which recording is performed on the medium, and a capped position at which the liquid ejecting surface is covered by the cap, a recess is formed in the support, the recess allowing the support not to interfere with the holder when the liquid ejecting head is located at the capped position, and the recess forms a portion of the opening.

According to the present aspect, the contact member can prevent the medium from coming into contact with the liquid ejection surface.

The recess is formed in the support, the recess allowing the support not to interfere with the holder when the liquid ejecting head is located at the capped position, and the recess forms a portion of the opening, so that paper dust tends to enter the liquid ejecting head via the opening. The effect and advantage of the first aspect described above can, however, suppress the adhesion of the paper dust to the cap.

In a fourth aspect according to the third aspect, the liquid ejecting apparatus further includes a rib provided at a bottom of the recess and configured to restrict movement of paper dust to the cap.

According to the present aspect, since a rib that restricts movement of paper dust to the cap is provided at the bottom of the recess, the rib can prevent the paper dust having entered the recess from moving toward the cap.

In a fifth aspect according to the second aspect, the liquid ejecting apparatus further includes an edge detector configured to detect an edge of the medium by moving in a medium width direction that is a direction intersecting with the medium conveyance direction, the edge detector is an optical sensor, a reflection suppressor configured to suppress reflection of detection light emitted from the edge detector is provided at a position where the reflection suppressor faces the edge detector, the reflection suppressor is formed by a gap provided between the shutter at the blocking position and the support, and the gap forms a portion of the opening.

In the configuration in which the reflection suppressor is formed by a gap provided between the shutter at the blocking position and the support, and the gap forms a portion of the opening, paper dust tends to enter the liquid ejecting head via the opening, and the paper dust tends to adhere to the cap. The effect and advantage of the first aspect described above can, however, suppress the adhesion of the paper dust to the cap.

Note that the present aspect is not necessarily an aspect according to the second aspect described above, and may instead be an aspect according to the third or fourth aspect described above.

In a sixth aspect according to the first aspect, the wall is provided to surround the cap.

According to the present aspect, since the wall is provided to surround the cap, the adhesion of the paper dust to the cap can be further suppressed.

Furthermore, the liquid can be accumulated inside the wall. When the liquid overflows from the cap, the configuration described above can prevent the overflowing liquid from spreading over a wide range inside the liquid ejecting apparatus and contaminating the interior of the liquid ejecting apparatus.

In addition, since the wall improves the rigidity around the cap, the cap can be uniformly brought into close contact with the liquid ejecting surface, so that the basic function of the cap can be satisfactorily provided.

Note that the present aspect is not necessarily an aspect according to the first aspect described above, and may instead be an aspect according to any of the second to fifth aspects described above.

In a seventh aspect according to the sixth aspect, the liquid ejecting apparatus further includes a base portion configured to support the cap, and the base portion has a discharge port via which the liquid overflowing from the wall is discharged.

According to the present aspect, in which the liquid ejecting apparatus further includes a base portion that supports the cap, and the base portion has a discharge port via which the liquid overflowing from the wall is discharged, when the liquid overflows from the wall, the configuration described above can prevent the overflowing liquid from spreading over a wide range inside the liquid ejecting apparatus and contaminating the interior of the liquid ejecting apparatus.

In an eighth aspect according to the first aspect, the cap is provided to be movable toward and away from the liquid ejection surface, and is pressed toward the liquid ejection surface.

According to the present aspect, since the cap is provided to be movable toward and away from the liquid ejection surface, and is pressed toward the liquid ejection surface, the cap can be preferably brought into close contact with the liquid ejecting surface.

Note that the present aspect is not necessarily an aspect according to the first aspect described above, and may instead be an aspect according to any of the second to seventh aspects described above.

In a ninth aspect according to the first aspect, the wall is displaceable in the first direction and a second direction opposite the first direction, and is pressed in the first direction, and in a state in which the cap is separate from the liquid ejecting surface, an end of the wall in the first direction is located in the first direction beyond an end of the cap in the first direction.

According to the present aspect, in a state in which the cap is separate from the liquid ejecting surface, the end of the wall in the first direction is located in the first direction beyond the end of the cap in the first direction, so that the wall effectively suppresses the adhesion of the paper dust to the cap.

In addition, since the wall is displaceable in the first direction and a second direction opposite to the first direction, and is pressed in the first direction, the wall can be retracted in the second direction when the cap comes into contact with the liquid ejection surface. The configuration described above can prevent the wall from hindering the sealing of the liquid ejection surface by the cap.

Note that the present aspect is not necessarily an aspect according to the first aspect described above, and may instead be an aspect according to any of the second to eighth aspects described above.

In a tenth aspect according to the first aspect, the wall has a suction hole, and is configured to suction paper dust via the suction hole.

According to the present aspect, since the wall has the suction hole at an end portion in the first direction, and can suction the paper dust via the suction hole, the adhesion of the paper dust to the cap can be more effectively suppressed.

Note that the present aspect is not necessarily an aspect according to the first aspect described above, and may instead be an aspect according to any of the second to ninth aspects described above.

The present disclosure will be specifically described below.

An inkjet printer 1 will be described below as an example of a recording apparatus that performs recording on a medium. The inkjet printer 1 is hereinafter simply referred to as a printer 1.

The X-Y-Z coordinate system shown in each figure is an orthogonal coordinate system in which the direction indicated by an arrow is a positive (+) direction and the direction opposite the positive (+) direction is a negative (−) direction. The X-axis direction is an apparatus width direction and is a width direction of the medium on which recording is performed. When viewed from an operator of the printer 1, the +X direction is oriented toward the left side, and the −X direction is oriented toward the right side. The X-axis direction is hereinafter referred to as a medium width direction or simply a width direction in some cases.

The Y-axis direction is an apparatus depth direction and is a direction along a medium conveyance direction at a position where the medium faces a line head 40, which will be described later. The +Y direction is a direction from the rear toward the front of the printer 1, and the −Y direction is a direction from the front toward the rear of the printer 1. The −Y direction is a medium conveyance direction during recording at a position where the medium faces the line head 40. The medium conveyance direction hereinafter means the −Y direction unless otherwise specified.

In the present embodiment, among the side surfaces that constitute the circumference of the printer 1, the side surface in the +Y direction is an apparatus front surface, and the side surface in the −Y direction is an apparatus rear surface.

The Z-axis direction is a direction along the vertical direction and is an apparatus height direction. The +Z direction is the vertically upward direction, and the −Z direction is the vertically downward direction.

Note in the following description that a direction in which the medium may be conveyed is referred to as “downstream”, and the direction opposite the “downstream” may be referred as “upstream”.

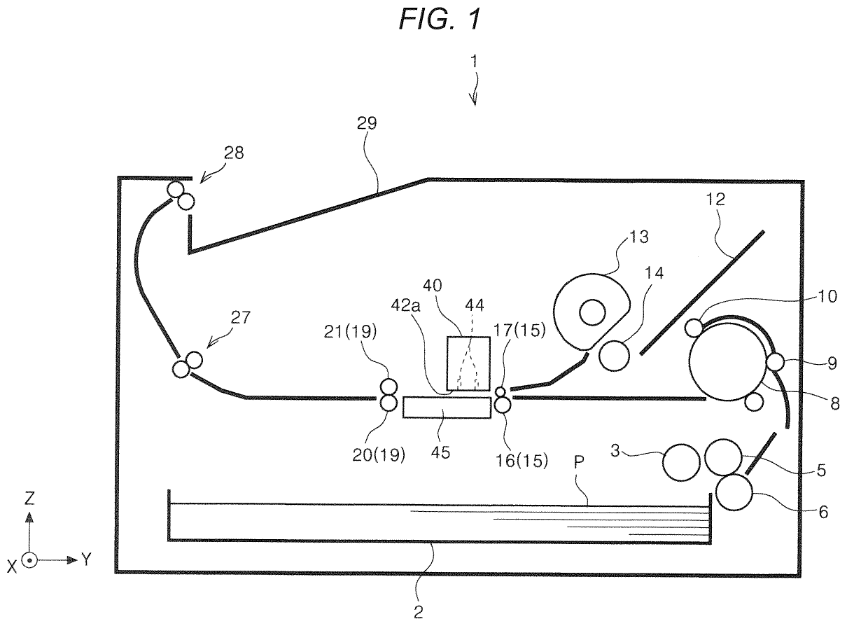

A medium conveyance path of the printer 1 will be described below with reference to FIG. 1. The printer 1 includes a medium storage cassette 2 at the bottom of the printer 1, as shown in FIG. 1. Reference character P denotes any of the media stored in the medium storage cassette 2. An example of the media is recording sheets. The medium storage cassette 2 is provided to be detachable via the apparatus front side.

A pickup roller 3 driven by a motor that is not shown is provided above the medium storage cassette 2. The pickup roller 3 is movable toward and away from the media stored in the medium storage cassette 2 and rotates while being in contact with one of the media stored in the medium storage cassette 2 to feed the medium from the medium storage cassette 2 in the +Y direction.

A feed roller 5 driven by a motor that is not shown and a separation roller 6, to which rotational torque is exerted by a torque limiter that is not shown, are provided downstream of the medium storage cassette 2. The medium fed from the medium storage cassette 2 is nipped by the feed roller 5 and the separation roller 6, so that the medium is separated from the other media and further fed downstream.

A reverse roller 8 driven by a motor that is not shown is provided downstream of the feed roller 5 and the separation roller 6. A first nip roller 9 and a second nip roller 10 are provided around the reverse roller 8, and the medium is nipped by the reverse roller 8 and the first nip roller 9, further nipped by the reverse roller 8 and the second nip roller 10, and conveyed. The direction in which the medium is conveyed is reversed from the +Y direction to the −Y direction by the reverse roller 8, and the medium is conveyed downstream.

A first conveyance roller pair 15 including a driving roller 16, which is driven by a motor that is not shown, and a driven roller 17, which is rotatable when driven, is provided downstream of the reverse roller 8. The medium is conveyed by the first conveyance roller pair 15 to a position where the medium faces the line head 40.

Note that the printer 1 includes a medium feed path extending from a medium support 12 in addition to a medium feed path extending from the medium storage cassette 2. The medium support 12 supports a medium in an inclining posture, and the supported medium is conveyed to the first conveyance roller pair 15 by a feed roller 13 driven by a motor that is not shown. Reference character 14 denotes a separation roller to which rotational torque is exerted by a torque limiter that is not shown.

The line head 40 is an example of a liquid ejecting head that ejects ink, which is an example of liquid, onto the medium to perform recording. The line head 40 is a liquid ejecting head in which multiple nozzles 44, via each of which the ink is ejected, are arranged to cover the entire medium in the medium width direction. The line head 40 is configured as a liquid ejecting head elongated in the medium width direction, and capable of performing recording on the entire medium width region without moving in the medium width direction.

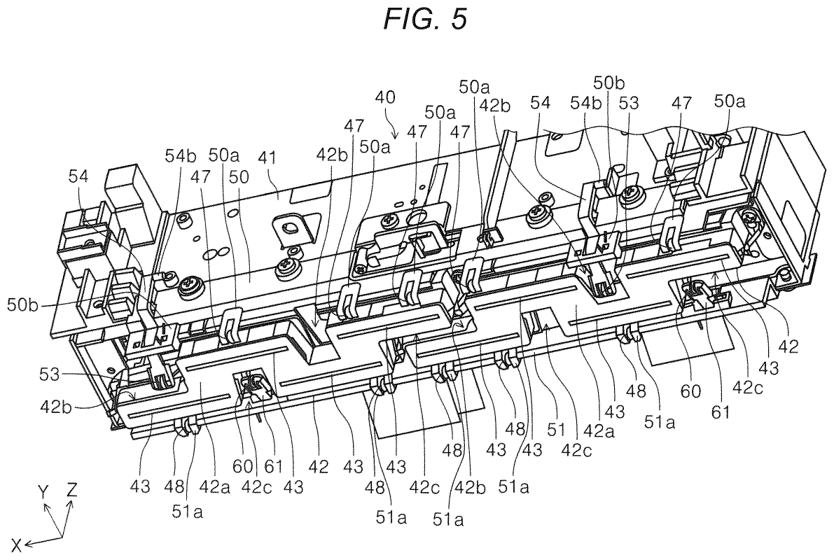

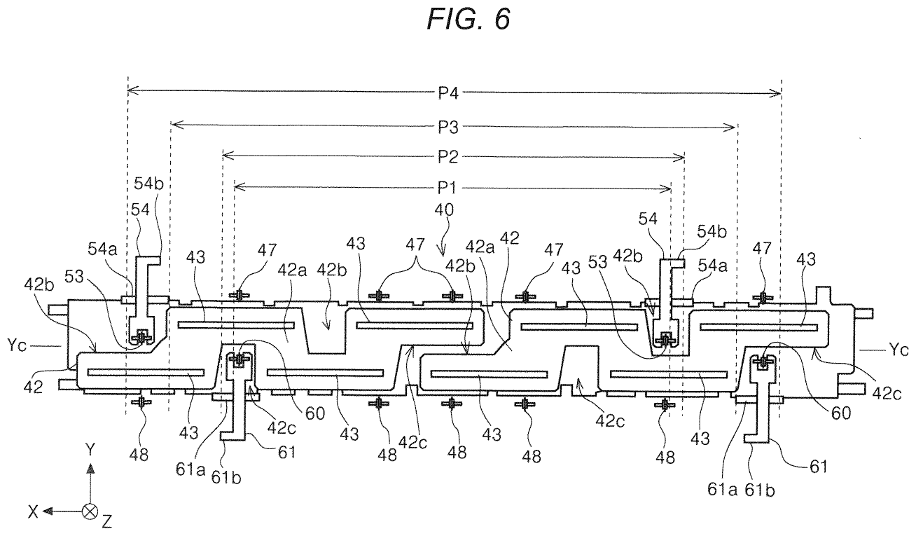

Reference character 42a denotes each head surface facing the medium. The head surfaces 42a may also be each referred to as a liquid ejecting surface or a nozzle surface. The head surfaces 42a are each formed by a plate member 42, which will be described later (see FIGS. 5 and 6). The head surfaces 42a are parallel to the medium conveyance direction.

The printer 1 includes an ink storage that is not shown, and the ink ejected from the line head 40 is supplied from the ink storage to the line head 40 via an ink tube that is not shown.

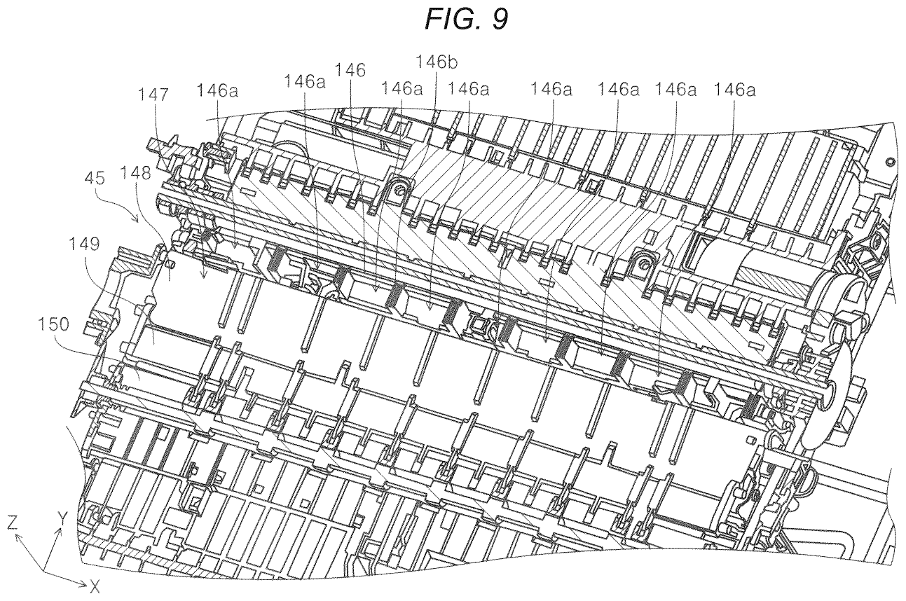

A head facing portion 45 is provided at a position where the head facing portion 45 faces the head surfaces 42a of the line head 40. The head facing portion 45 according to the present embodiment is provided with a shutter 147 (see FIG. 9), which will be described later. The head facing portion 45 supports the medium to define a gap between the medium and the head surfaces 42a. The gap between the head facing portion 45 and the head surfaces 42a is hereinafter referred to as a platen gap in some cases.

A second conveyance roller pair 19 including a driving roller 20, which is driven by a motor that is not shown, and a driven roller 21, which is rotatable when driven, is provided downstream of the line head 40. The medium on which recording has been performed is conveyed downstream by the second conveyance roller pair 19.

A third conveyance roller pair 27 is provided downstream of the second conveyance roller pair 19, and a discharge roller pair 28 is further provided downstream of the third conveyance roller pair 27. A path between the third conveyance roller pair 27 and the discharge roller pair 28 is configured as a face-down discharge path, and the medium on which recording has been performed is discharged to a discharge tray 29 by the discharge roller pair 28 with the latest recorded surface facing down.

The operation of raising and lowering the line head 40 will be subsequently described.

The line head 40 is movably provided in a direction in which the line head 40 moves toward and away from the head facing portion 45, that is, in the direction in which the platen gap is adjusted. In the present embodiment, the direction in which the platen gap is adjusted is parallel to the Z-axis direction. Hereinafter, the movement of the line head 40 in the +Z-axis direction may be referred to as “raising”, and the movement of the line head 40 in the −Z direction may be referred to as “lowering”.

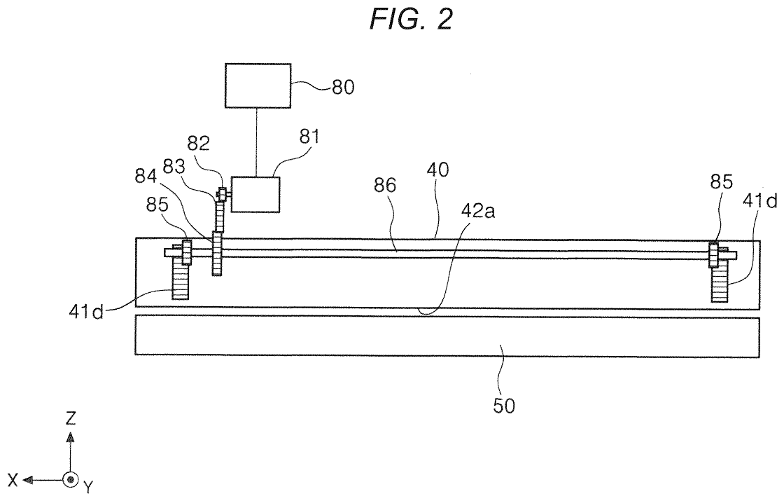

FIG. 2 shows a mechanism that adjusts the platen gap, reference character 81 denoting a head moving motor that is a drive source for raising and lowering the line head 40, reference character 80 denoting a controller that controls the head moving motor 81. The controller 80 is a controller responsible for controlling the entire printer 1.

A motor gear 82 is provided at a motor shaft of the head moving motor 81, and the motor gear 82 transmits a driving force to a pinion gear 85 via gears 83 and 84. The gear 84 and the pinion gear 85 are fixed to a shaft 86.

The line head 40 is held by a guide member that is not shown so as to be displaceable in the Z-axis direction. A rack 41d is formed along the Z-axis direction in the line head 40, and the pinion gear 85 engages with the rack 41d to form a rack and pinion mechanism.

The rotation of the motor shaft of the head moving motor 81 rotates the pinion gear 85, so that the line head 40 is raised and lowered.

Note that the rack and pinion mechanism configured with the rack 41d and the pinion gear 85 is provided near each end of the line head 40 in the medium width direction.

When raised, the line head 40 comes into contact with a raised movement restrictor that is not shown, so that a further raised movement of the line head 40 is restricted. The controller 80 can grasp that the line head 40 is located at a raised movement limit position by detecting an increase in a motor drive current value when the line head 40 comes into contact with the raised movement restrictor.

An encoder sensor that is not shown is provided in the head moving motor 81, so that the controller 80 can detect the amount of rotation of the motor shaft of the head moving motor 81. The controller 80 can thus detect the amount of movement of the line head 40 from the raised movement limit position, that is, can grasp the current position of the line head 40.

The controller 80 raises and lowers the line head 40 in accordance with the thickness of the medium based on the medium type contained in received print data to adjust the platen gap. For example, the position of the line head 40 that performs recording on plain paper is called a first recording position, and when recording is performed on special paper thicker than plain paper, the line head 40 is positioned at a second recording position higher than the first recording position.

In addition to the multiple recording positions described above, the region over which the line head 40 is moved includes a capped position that is a position when the head surfaces 42a are capped by caps 71, which will be described later, a wiping position that is a position where the head surfaces 42a are wiped by a wiper 36, which will be described later, a wiper separation position higher than the wiping position, and a retracted position higher than the wiper separation position.

In the present embodiment, the aforementioned positions of the line head 40 are arranged in the +Z direction as follows: the capped position; a first recording position; a second recording position; the wiping position; the wiper separation position; and the retracted position.

When the line head 40 is moved to the retracted position, which is the uppermost position within the movement region, the platen gap becomes the widest. The widest platen gap allows the operator to remove a jammed medium.

The wiping position and the wiper separation position will be described later.

The wiper 36 will next be described.

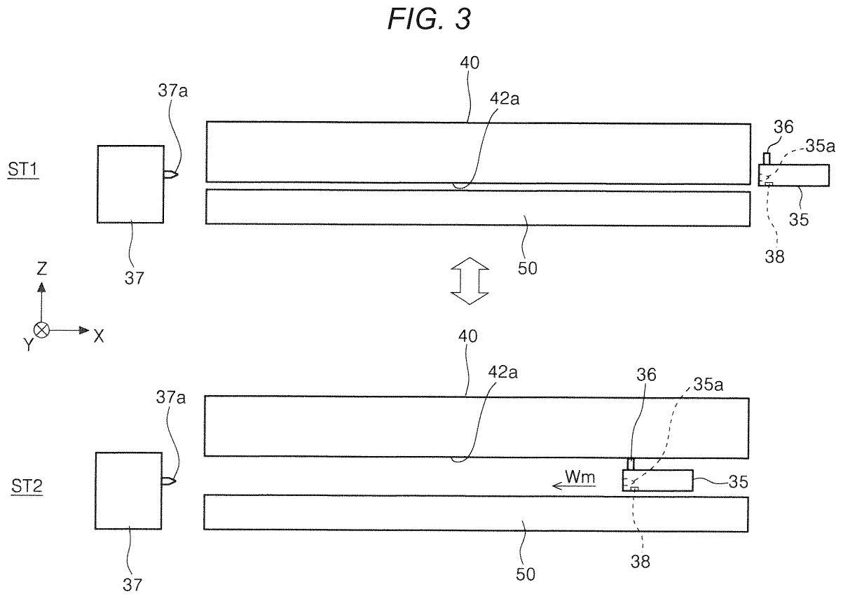

The printer 1 includes a wiper carriage 35, which is moved in the X-axis direction by a motor that is not shown, as shown in FIG. 3. In the present embodiment, a position indicated in a state ST1 in FIG. 3, that is, an end position in the +X direction is set as a home position of the wiper carriage 35.

The wiper carriage 35 is formed in the shape of a box having an open upper side, and is provided with the wiper 36. The wiper 36 is made of an elastic material such as rubber, and particularly wipes head chips 43 (see FIGS. 5 and 6), which will be described later, of the head surfaces 42a as the wiper carriage 35 in elastic contact with the head surfaces 42a is moved in the medium width direction. The ink removed by the wiping operation is accumulated in the wiper carriage 35.

A fitting hole 35a is provided in a −X-side end portion of the wiper carriage 35. A check valve that is not shown is provided in the fitting hole 35a, and prevents the ink accumulated in the wiper carriage 35 from leaking.

An ink collector 37 is provided in a −X-side end portion of the region over which the wiper carriage 35 is moved. The ink collector 37 includes a suction portion 37a, which can be fitted into the fitting hole 35a of the wiper carriage 35. When the wiper carriage 35 is moved to the end in the −X direction, the suction portion 37a is fitted into the fitting hole 35a. When the suction portion 37a is fitted into the fitting hole 35a, the check valve described above is opened. In this state, a pump that is not shown but is provided in the ink collector 37 is driven to suction the ink accumulated in the wiper carriage 35.

The state ST1 in FIG. 3 shows a state in which the line head 40 is at one of the recording positions. To cause the wiper 36 to wipe the head surfaces 42a from this state, the line head 40 is raised to the wiping position as shown by the change from the state ST1 to a state ST2 in FIG. 3. A gap into which the wiper carriage 35 enters is thus provided between the line head 40 and the head facing portion 45, and the wiper 36 can come into contact with the head surfaces 42a.

In this state, the wiper carriage 35 is moved as indicated by an arrow Wm to cause the wiper 36 to wipe the head surfaces 42a.

Note that after the wiper 36 is moved to the end in the −X direction, that is, after the wiper 36 wipes the head surfaces 42a, the wiper carriage 35 is moved in the +X direction to return to the home position at the end in the +X direction. Prior to this operation, the line head 40 is slightly raised to the wiper separation position, where the wiper 36 is not in contact with the head surfaces 42a.

An edge detector 38 provided in the wiper carriage 35 will be subsequently described.

The edge detector 38, which detects an edge of the medium, is provided at the bottom of the wiper carriage 35.

The edge detector 38 is an optical sensor and includes a light emitter (not shown) that emits detection light in the −Z direction and a light receiver (not shown) that receives a reflected component of the detection light. The intensity of the reflected component in the presence of a medium is higher than that in the absence of a medium. The controller 80 can therefore detect an edge of the medium based on information detected by the edge detector 38, and can hence detect the size of the medium in the width direction.

The wiper carriage 35 is movable in the medium width direction, and the edge detector 38 is provided in the wiper carriage 35, as described above. Moving the wiper carriage 35 in the medium width direction in a state in which the medium is positioned at a position where the medium can be detected by the edge detector 38 therefore allows the edge detector 38 to perform edge detection. Note that the edge detection means detecting one or both of the +X-side edge and the −X-side edge of the medium.

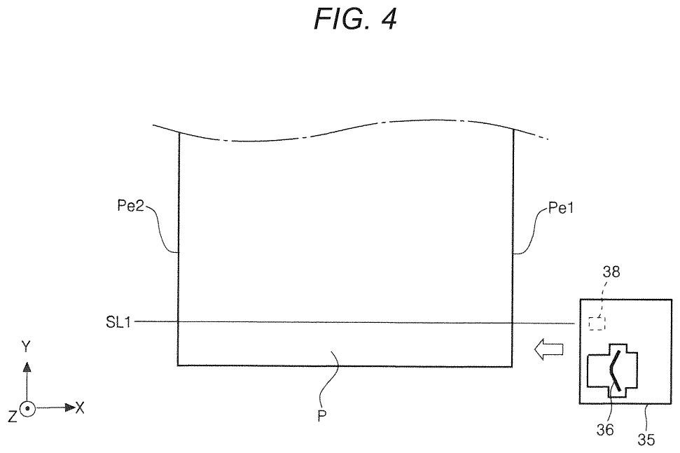

In FIG. 4, reference character Pe1 denotes the +X-side edge of the medium P, and reference character Pe2 denotes the −X-side edge of the medium P. A line SL1 is a detection line used by the edge detector 38. The positions of the edge Pe1 and the edge Pe2 can be detected by moving the wiper carriage 35 in the direction indicated by the arrow (−X direction) by way of example in the state in which the medium is positioned at the position where the medium P can be detected by the edge detector 38, as shown in FIG. 4. As a result, the size of the medium P in the width direction can be detected.

Note that conveying the medium in the state in which the medium is positioned at the position where the edge detector 38 can detect the medium in the medium width direction, for example, the center position in the medium width direction allows detection of the edge in the −Y direction, that is, the front edge of the medium, and the edge in the +Y direction, that is, the rear edge of the medium.

The line head 40 and a contact member will be subsequently described with reference to FIG. 5 and subsequent drawings.

The line head 40 includes plate members 42 at a base 41, as shown in FIG. 5. The base 41 is a structure incorporating a path along which the ink supplied from the ink storage that is not shown is supplied to the head chips 43.

Each of the plate members 42 is a metal plate and forms the head surface 42a.

The plate members 42 are each provided with multiple head chips 43. The head chips 43 are each provided with multiple nozzles 44 (see FIG. 1) along the medium width direction. The plate members 42 and the head chips 43 are provided to be flush with each other.

In the present embodiment, the line head 40 includes two plate members 42 along the medium width direction. In each of the plate members 42, the head chips 43 are alternately disposed at upstream and downstream positions along the X-axis direction, that is, the medium width direction. In each of the plate members 42, two head chips 43 are provided at the upstream positions along the medium width direction, and two head chips 43 are provided at the downstream positions along the medium width direction. Therefore, in the line head 40, four head chips 43 are provided at the upstream positions along the medium width direction, and four head chips 43 are provided at the downstream positions along the medium width direction.

The head surfaces 42a of the line head 40 further each include upstream clearances 42b and downstream clearances 42c. The upstream clearances 42b and the downstream clearances 42c are each formed as a space having a predetermined height in the +Z direction from the head surface 42a.

In the present embodiment, the plate members 42 are each provided with two upstream clearances 42b located upstream in the medium conveyance direction. In each of the plate members 42, one of the upstream clearances 42b is provided between two head chips 43 adjacent to each other in the medium width direction. In each of the plate members 42, the other upstream clearance 42b is provided at a position shifted in the +X direction from the head chip 43 located at a position shifted in the +X direction out of the two head chips 43.

Similarly, in the present embodiment, the plate members 42 are each provided with two downstream clearances 42c located downstream in the medium conveyance direction. In each of the plate members 42, one of the downstream clearances 42c is provided between two head chips 43 adjacent to each other in the medium width direction. In each of the plate members 42, the other downstream clearance 42c is provided at a position shifted in the −X direction from the head chip 43 located at a position shifted in the −X direction out of the two head chips 43.

The contact member integrated with the line head 40 will be subsequently described.

The medium passing through the space between the line head 40 and the head facing portion 45, particularly end portions in the medium width direction are contaminated in some cases because front and rear end portions of the medium curl and rise, so that the portions come into contact with the head surfaces 42a. It is therefore preferable that the line head 40 is provided with a contact member that comes into contact with the medium to suppress contact between the medium and the head surfaces 42a.

In the present embodiment, upstream fixed rollers 47, downstream fixed rollers 48, upstream movable rollers 53, and downstream movable rollers 60 are provided as the contact member. The rollers described above are each a toothed roller having teeth at the outer circumference, and can therefore prevent the ink from attaching thereto and from then attaching to the medium.

Note that “movable rollers” simply referred to in the following description refer to the upstream movable rollers 53 and the downstream movable rollers 60.

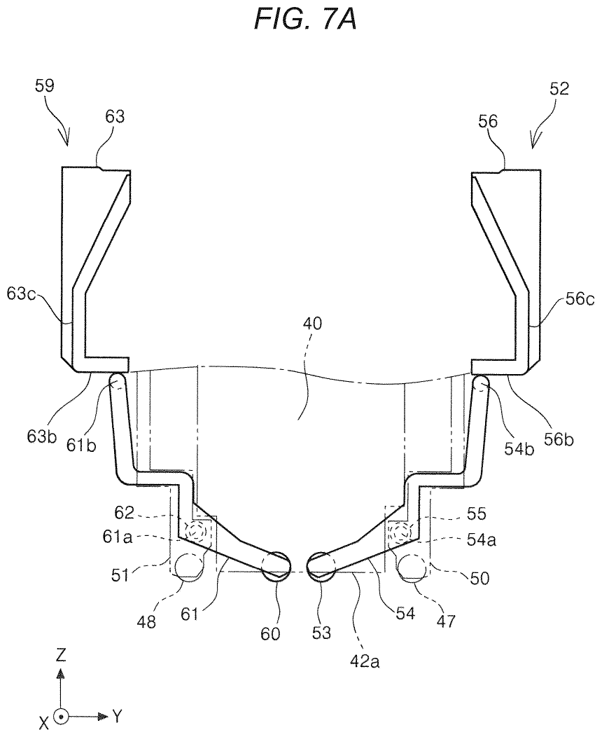

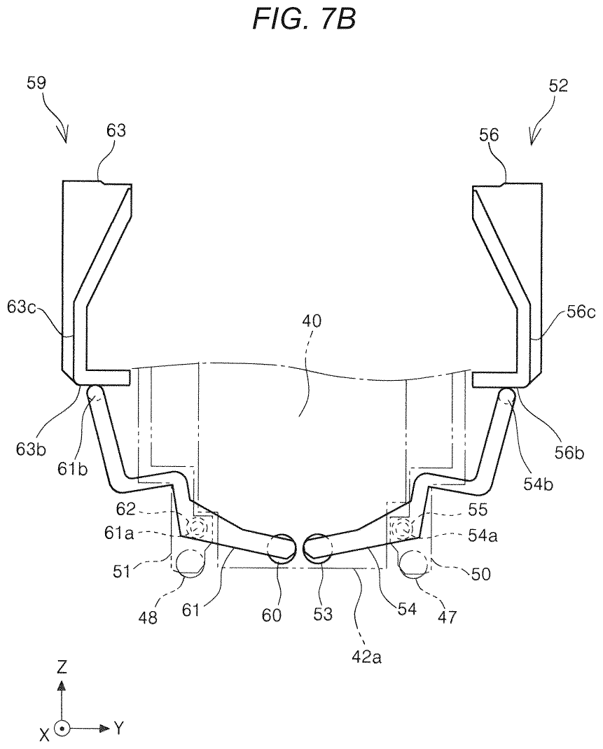

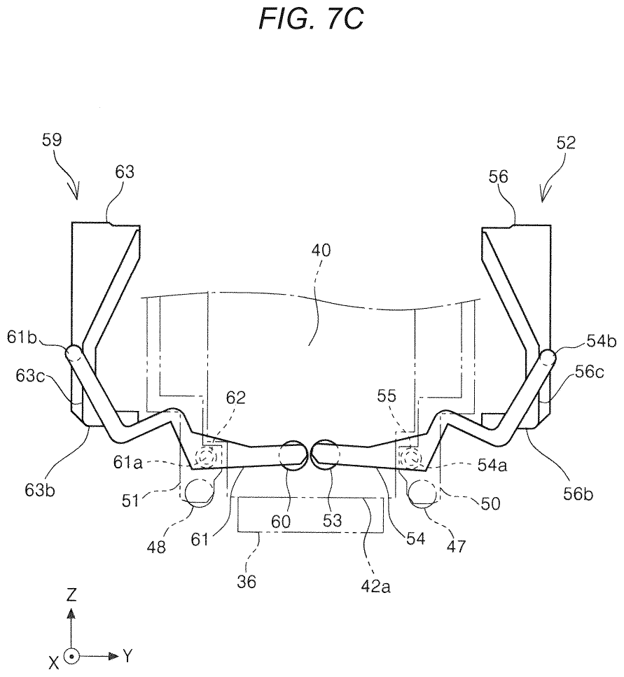

The upstream fixed rollers 47 and the downstream fixed rollers 48 protrude from the head surfaces 42a in the −Z direction, that is, toward the head facing portion 45, as shown in FIGS. 7A to 7C, irrespective of the position of the line head 40. The upstream fixed rollers 47 and the downstream fixed rollers 48 thus suppress contact between the medium and the head surfaces 42a.

The line head 40 includes an upstream frame 50 at the +Y-side side surface of the line head 40, that is, at the upstream side surface in the medium conveyance direction, and includes a downstream frame 51 at the −Y-side side surface of the line head 40, that is, at the downstream side surface in the medium conveyance direction, as shown in FIG. 5.

The upstream fixed rollers 47 are rotatably supported by roller holders 50a of the upstream frame 50. The roller holders 50a are an example of a holder that holds the contact member. The multiple upstream fixed rollers 47 are provided in the upstream frame 50 along the medium width direction. The upstream fixed rollers 47 are located at positions shifted from the plate members 42 in the +Y direction, that is, upstream of the plate members 42 in the medium conveyance direction, as shown in FIG. 6. Note that FIG. 6 does not show the upstream frame 50 or the downstream frame 51 for convenience of illustration.

The downstream fixed rollers 48 are rotatably supported by roller holders 51a of the downstream frame 51, as shown in FIG. 5. The multiple downstream fixed rollers 48 are provided in the downstream frame 51 along the medium width direction. The downstream fixed rollers 48 are located at positions shifted from the plate members 42 in the −Y direction, that is, downstream of the plate members 42 in the medium conveyance direction, as shown in FIG. 6.

The upstream movable rollers 53 and the downstream movable rollers 60 are displaceable to first and second positions that are positions relative to the head surfaces 42a. FIG. 7A shows the first position of the movable rollers. The first position is a position where the movable rollers can interfere with the wiper 36 and can come into contact with the medium. In other words, the first position of the movable rollers is a position located inside the movement trajectory of the wiper 36, which wipes the head surfaces 42a, and where the movable rollers can come into contact with the medium. In the present embodiment, the first position of the movable rollers is a position where the movable rollers protrude from the head surfaces 42a in the −Z direction.

The second position of the movable rollers is a position where the movable rollers do not interfere with the wiper 36. Specifically, the second position of the movable rollers is a position where the movable rollers are retracted from the head surfaces 42a in the +Z direction. FIG. 7C shows the second position of the movable rollers.

Positioning the movable rollers at the first position as described above can suppress contact between the medium and the head surfaces 42a. Positioning the movable rollers at the second position can prevent the movable rollers from hindering the wiper 36 from wiping the head surfaces 42a. It is therefore not necessary to dispose multiple wipers 36 to avoid the movable rollers, so that an increase in cost of the printer 1 can be suppressed. In addition, replacement of the wiper 36 with another does not cause significant increases in the man-hour and part cost required for the replacement.

A displacement mechanism that displaces the movable rollers to the first and second positions will be subsequently described primarily with reference to FIGS. 7A to 7C. Note that FIGS. 7A to 7C primarily show, for convenience of illustration, the configurations of upstream displacement mechanisms 52 and downstream displacement mechanisms 59 indicated by solid lines, and the other configurations indicated by two-dot chain lines.

In the present embodiment, the upstream displacement mechanisms 52, which displace the upstream movable rollers 53, and the downstream displacement mechanisms 59, which displace the downstream movable rollers 60, are provided as the displacement mechanism that displaces the movable rollers to the first and second positions.

The upstream displacement mechanisms 52 and the downstream displacement mechanisms 59 have the same basic configuration, and are bilaterally symmetrical when viewed in the medium width direction, as shown in FIGS. 7A to 7C.

The upstream displacement mechanisms 52 each include an upstream support member 54 and an upstream cam member 56. The upstream support member 54 is a member that rotatably supports the upstream movable roller 53, and can pivot around a pivotal shaft 54a to change its posture to a first pivotal posture (FIG. 7A) in which the upstream movable roller 53 is at the first position and a second pivotal posture (FIG. 7C) in which the upstream movable roller 53 is at the second position. In the present embodiment, the axial center line of the pivotal shaft 54a is parallel to the X-axis direction. The pivotal shaft 54a is supported by a pivotal motion support 50b (see FIG. 5) of the upstream frame 50.

The upstream support member 54 is pressed by a helical spring 55 as a pressing member in the counterclockwise direction in FIGS. 7A to 7C, that is, in the direction in which the upstream movable roller 53 moves toward the first position.

The upstream support member 54 includes a cam follower 54b as a portion engageable with the upstream cam member 56.

The upstream cam member 56 is a member provided independently of the line head 40 and is engageable with the upstream support member 54. The upstream cam member 56 is provided at a frame that is not shown. The upstream support member 54 is movable relative to the upstream cam member 56 in the Z-axis direction as the line head 40 is raised and lowered.

The upstream cam member 56 has a horizontal cam surface 56b along the X-Y plane and a vertical cam surface 56c along the X-Z plane.

The downstream displacement mechanisms 59 each include a downstream support member 61 and a downstream cam member 63. The downstream support member 61 is a member that rotatably supports the downstream movable roller 60, and can pivot around a pivotal shaft 61a to change its posture to the first pivotal posture (FIG. 7A), in which the downstream movable roller 60 is at the first position, and the second pivotal posture (FIG. 7C), in which the downstream movable roller 60 is at the second position. In the present embodiment, the axial center line of the pivotal shaft 61a is parallel to the X-axis direction. The pivotal shaft 61a is supported by the downstream frame 51 (see FIG. 5).

The downstream support member 61 is pressed by a helical spring 62 as the pressing member in the clockwise direction in FIGS. 7A to 7C, that is, in the direction in which the downstream movable roller 60 moves toward the first position.

The downstream support member 61 includes a cam follower 61b as a portion engageable with the downstream cam member 63.

The downstream cam member 63 is a member provided independently of the line head 40 and is engageable with the downstream support member 61. The downstream cam member 63 is provided at the frame that is not shown. The downstream support member 61 is movable relative to the downstream cam member 63 in the Z-axis direction as the line head 40 is raised and lowered.

The downstream cam member 63 has a horizontal cam surface 63b along the X-Y plane and a vertical cam surface 63c along the X-Z plane.

FIG. 7A shows a state in which the line head 40 is at the recording position, the movable rollers, that is, the upstream movable rollers 53 and the downstream movable rollers 60 are at the first position, and the upstream support members 54 and the downstream support members 61 have the first pivotal posture. From this state, to wipe the head surfaces 42a with the wiper 36 (see FIG. 3), the line head 40 is raised toward the wiping position. As the line head 40 is raised, the horizontal cam surfaces 56b guide the upstream support members 54 toward the second pivotal posture, and the horizontal cam surfaces 63b guide the downstream support members 61 toward the second pivotal posture, as shown in the change from FIG. 7A to FIG. 7B.

When the line head 40 is further raised, the cam followers 54b of the upstream support members 54 move from the horizontal cam surfaces 56b to the vertical cam surfaces 56c, and the line head 40 is raised with the upstream support members 54 maintained in the second pivotal posture, as shown in FIG. 7C.

Similarly, the cam followers 61b of the downstream support members 61 move from the horizontal cam surfaces 63b to the vertical cam surfaces 63c, and the line head 40 is raised with the downstream support members 61 maintained in the second pivotal posture.

When the line head 40 is moved to the wiping position shown in FIG. 7C, the upstream movable rollers 53 and the downstream movable rollers 60 are retracted from the head surfaces 42a, so that the wiper 36 can wipe the head surfaces 42a.

Note that when the line head 40 is lowered toward the recording position from the state shown in FIG. 7C, the state of the line head 40 changes in a manner opposite the manner described above, that is, the upstream cam members 56 guide the upstream support members 54 from the second pivotal posture to the first pivotal posture, and the downstream cam members 63 guide the downstream support members 61 from the second pivotal posture to the first pivotal posture. As a result, the upstream movable roller 53 and the downstream movable roller 60 are displaced from the second position to the first position.

As described above, the movable rollers can be displaced in conjunction with the displacement operation of the line head 40 in the simple configuration including the upstream support members 54, the upstream cam members 56, the downstream support members 61, and the downstream cam members 63.

Furthermore, the displacement mechanism that displaces the movable rollers, that is, the upstream displacement mechanisms 52 and the downstream displacement mechanisms 59 convert the displacement operation of the line head 40 into the displacement operation of the movable rollers, displace the movable rollers from the first position to the second position when the line head 40 is displaced from the recording position to the retracted position, and displace the movable rollers from the second position to the first position when the line head 40 is displaced from the retracted position to the recording position, as described above. A power source for displacing the movable rollers is therefore not necessary, so that an increase in cost of the apparatus can be suppressed.

In the present embodiment, the movable rollers are displaced to the first position and the second position when moved in a direction that intersects with the head surfaces 42a. An increase in size of the line head 40 in the medium conveyance direction can therefore be suppressed as compared with a configuration in which the movable rollers are moved along the medium conveyance direction.

Now, referring back to FIG. 6, the positional relationship between the medium having various sizes and the rollers will be described.

In FIG. 6, a range P1 is a range through which a medium having a minimum size assumed to be used passes, and corresponds, for example, to the widthwise dimension (about 140 mm) of a half-letter-size medium. A range P2 corresponds to the widthwise dimension (148 mm) of an A5-size medium. A range P3 corresponds to the widthwise dimension (182 mm) of a B5-size medium. A range P4 corresponds to the widthwise dimension (about 210 mm) of an A 4-size medium.

The upstream fixed rollers 47 and the downstream movable rollers 60 prevent a +X-side end portion of each of the media corresponding to the ranges P1, P2, and P3 from coming into contact with the head surfaces 42a, and the upstream movable rollers 53 and the downstream fixed rollers 48 prevent a −X-side end portion of the medium from coming into contact with the head surfaces 42a.

The upstream movable rollers 53 and the downstream fixed rollers 48 prevent a +X-side end portion of the medium corresponding to the range P4 or a medium larger than the range P4 from coming into contact with the head surfaces 42a, and the upstream fixed rollers 47 and the downstream movable rollers 60 prevent a −X-side end portion of the medium from coming into contact with the head surfaces 42a.

The upstream movable rollers 53 and the downstream movable rollers 60 are each disposed at a position close to a center position Yc of the head surfaces 42a in the medium conveyance direction. This is because the upstream movable rollers 53 enter the upstream clearances 42b, and the downstream movable rollers 60 enter the downstream clearances 42c.

Accordingly, in the present embodiment, the upstream movable rollers 53 and the downstream movable rollers 60 are each located between the upstream head chips 43 and the downstream head chips 43 in the medium conveyance direction.

The configuration described above can preferably prevent the end portions of each of the media in the medium width direction from coming into contact with the head surfaces 42a.

Note in the present embodiment that the downstream fixed rollers 48 are disposed downstream of the upstream movable rollers 53, and the upstream fixed rollers 47 are disposed upstream of the downstream movable rollers 60. The downstream fixed rollers 48 are disposed downstream of the three upstream fixed rollers 47 located in a center region in the medium width direction.

According to the configuration described above, the upstream fixed rollers 47 first prevent any of the media corresponding to the ranges P1, P2, and P3 from coming into contact with the head surfaces 42a as the medium is conveyed, the upstream movable rollers 53 located in the −X direction and the downstream movable rollers 60 located in the +X direction then prevent the medium from coming into contact with the head surfaces 42a, and the downstream fixed rollers 48 then prevent the medium from coming into contact with the head surfaces 42a.

A the medium corresponding to the range P4 is conveyed, the upstream fixed rollers 47 first prevent the medium from coming into contact with the head surfaces 42a, the two upstream movable rollers 53 and the two downstream movable rollers 60 then prevent the medium from coming into contact with the head surfaces 42a, and the downstream fixed rollers 48 then prevent the medium from coming into contact with the head surfaces 42a.

The configuration described above preferably prevents any of the media from coming into contact with the head surfaces 42a.

The multiple movable rollers are provided when viewed in the medium width direction, and the multiple movable rollers include the upstream movable rollers 53 and the downstream movable rollers 60 located downstream of the upstream movable rollers 53 in the medium conveyance direction. The rollers can preferably prevent contact between the medium with the head surfaces 42a.

In the line head 40, the head surfaces 42a each include the multiple head chips 43 each having nozzles 44. The multiple head chips 43 are disposed along the width direction alternately at the upstream positions and the downstream positions in the medium conveyance direction. The head surfaces 42a each have the upstream clearances 42b, which are provided upstream in the medium conveyance direction and do not interfere with the head chips 43. The downstream clearances 42c, which do not interfere with the head chips 43, are further provided downstream in the medium conveyance direction. When the movable rollers are at the first position, the movable rollers enter the upstream clearances 42b and the downstream clearances 42c.

The movable rollers can therefore be brought close to the center position of the head surfaces 42a in the medium conveyance direction. As a result, the contact between the medium and the head surfaces 42a can be preferably prevented.

Note that the recess may only be one of the upstream clearances 42b and the downstream clearances 42c. That is, only one of the upstream movable roller 53 and the downstream movable roller 60 may be provided.

The caps 71 will be subsequently described.

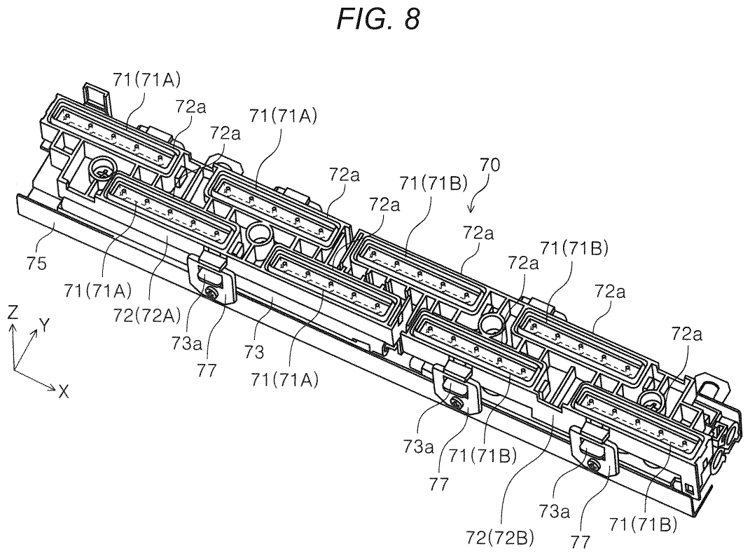

The head chips 43 (see FIGS. 5 and 6) are disposed along the X-axis direction, that is, the medium width direction alternately at the upstream positions and the downstream positions, as described above. In the present embodiment, four head chips 43 are provided at the upstream positions along the medium width direction, and four head chips 43 are provided at the downstream positions along the medium width direction. The caps 71, which cover the head chips 43, are disposed along the medium width direction alternately at upstream positions and downstream positions, as shown in FIG. 8.

Since the head chips 43 are provided at the head surfaces 42a, the caps 71 can also be referred to as members that cover portions of the head surfaces 42a. Furthermore, since the head chips 43 are each provided with the nozzles 44, the caps 71 can also be referred to as members that cover the nozzles 44.

The multiple caps 71 constitute a cap unit 70. The cap unit 70 is provided below a shutter 147, which constitutes the head facing portion 45 and will be described later.

The cap unit 70 includes multiple caps 71 in holding members 72.

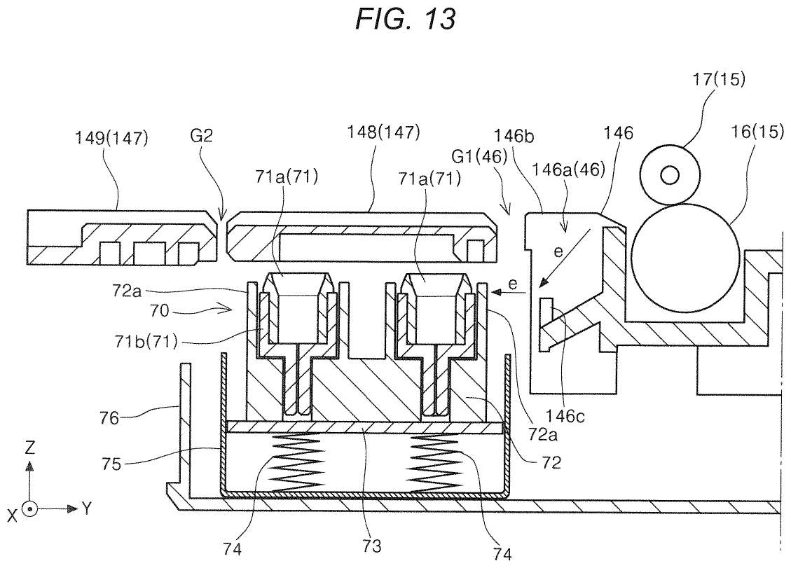

The caps 71 each have a shape elongated in the X-axis direction, and include a cap body 71b (see FIG. 13) made of a resin material or the like, and an elastic portion 71a (see FIG. 13), which is a portion that comes into contact with the head surface 42a and is made of an elastic material such as rubber.

The cap bodies 71b are held by the holding members 72. In the present embodiment, the holding members 72 are made of a resin material. In the present embodiment, two holding members 72 are provided along the width direction. In the present embodiment, holding members 72 each hold two of the four caps 71 provided at the upstream positions along the width direction, and two of the four caps 71 provided at the downstream positions along the width direction.

In FIG. 8, reference numerals 72A and 72B denote different holding members 72. The caps 71 held by the holding member 72A have reference character 71A, and the caps 71 held by the holding member 72B have reference character 71B.

The holding members 72 are provided in a first support frame 73, as shown in FIG. 13. The first support frame 73 is housed in a second support frame 75. The first support frame 73, the holding members 72, and the caps 71 are provided to be displaceable as a unit along the Z-axis direction. Springs 74, which are an example of the pressing member, are provided between the first support frame 73 and the second support frame 75, and press the first support frame 73, that is, the caps 71 in the +Z direction.

That is, the caps 71 are provided to be movable toward and away from the head surfaces 42a, and are pressed toward the head surfaces 42a. The caps 71 can thus preferably come into close contact with the head surfaces 42a.

Restricted portion 73a are formed at the first support frame 73, as shown in FIG. 8. The second support frame 75 is provided with restricting members 77. The restricting members 77 each have an opening, and a limit of the movement of the first support frame 73, that is, the caps 71 in the +Z direction is defined when the restricted portions 73a enter the openings.

The cap unit 70 includes the caps 71, the holding members 72, the first support frame 73, the second support frame 75, and the springs 74, as described above.

The thus configured cap unit 70 is provided at a tray-shaped base portion 76, as shown in FIG. 13.

A waste liquid tube that is not shown is coupled to the caps 71. The waste liquid tube is coupled to a pump that is not shown. When the pump is operated in the state in which the caps 71 cover the head surfaces 42a, a negative pressure is generated in the caps 71, so that the ink is suctioned via the nozzles 44 of the line head 40.

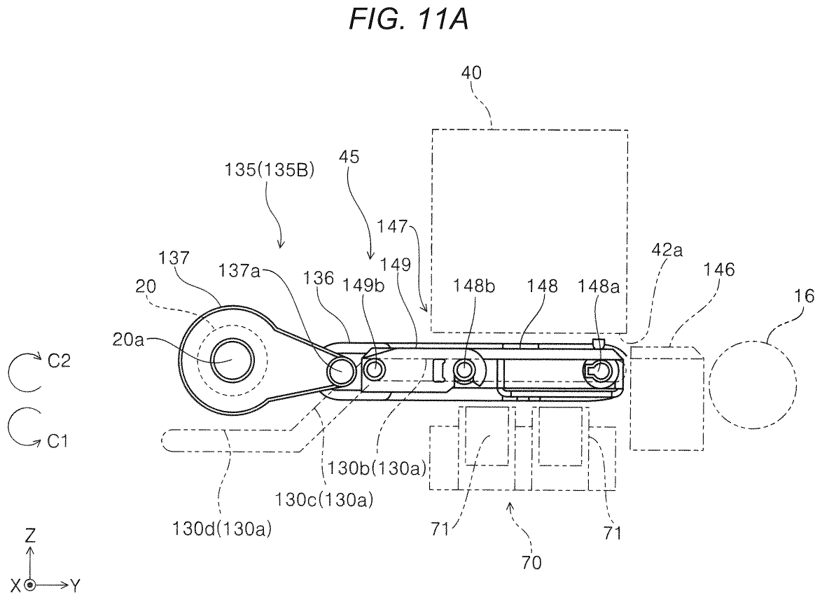

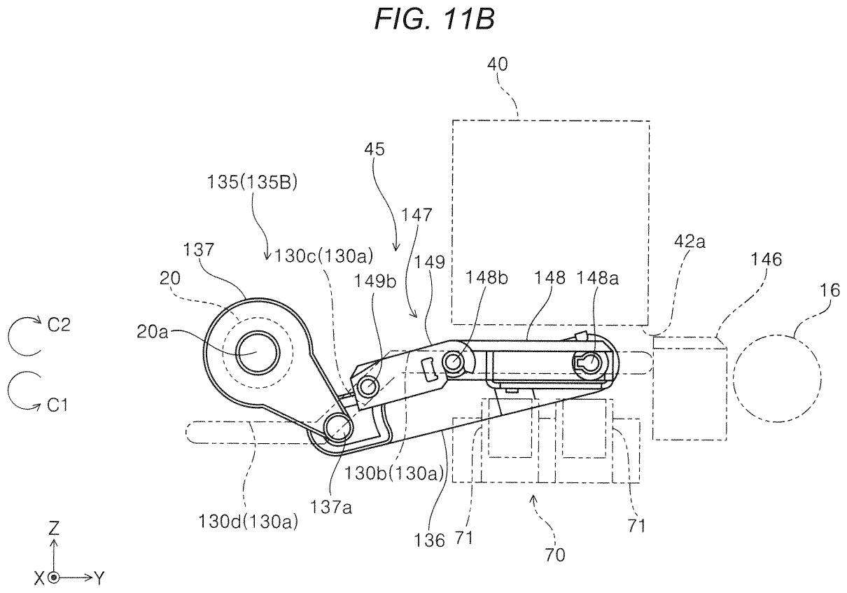

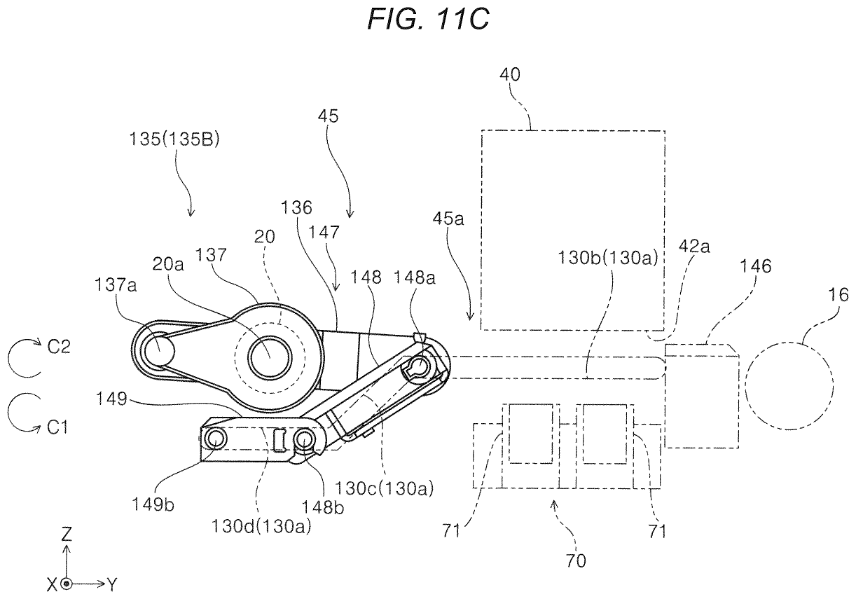

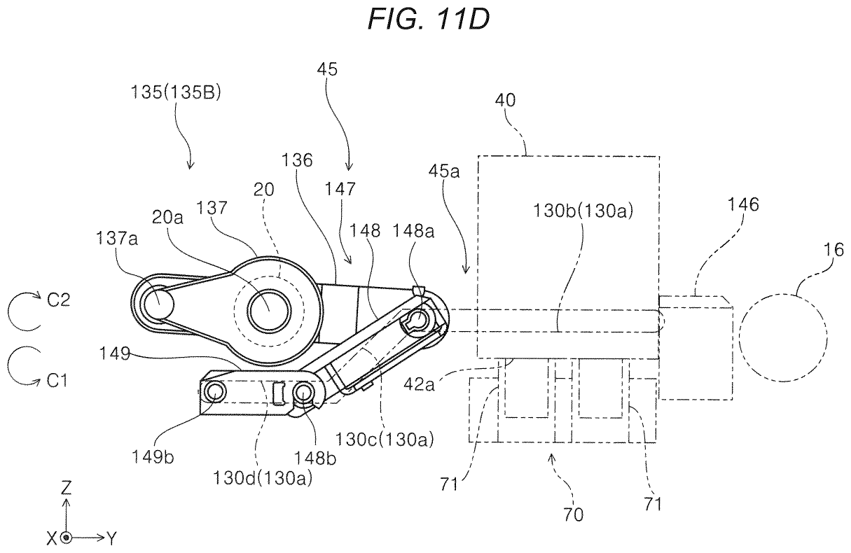

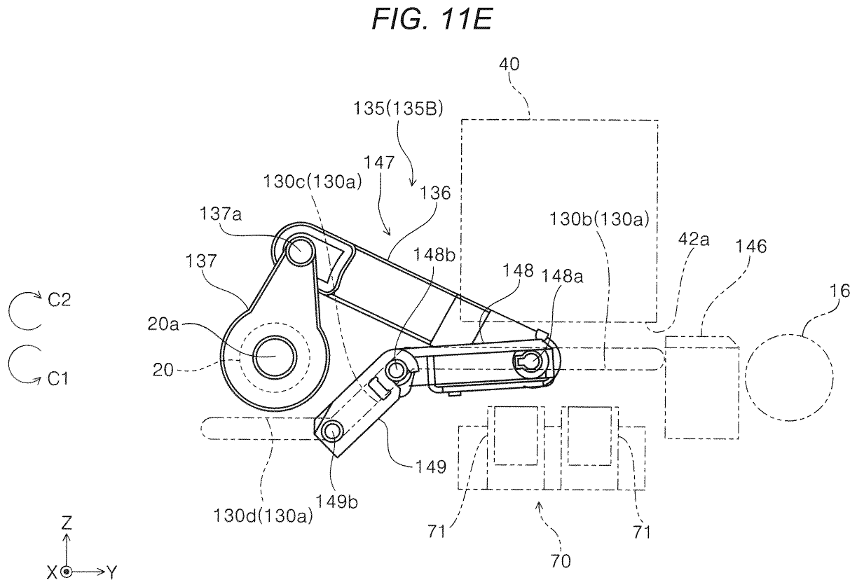

The caps 71 are exposed when the shutter 147, which will be described later, is moved from a blocking position to an open position. That is, the shutter 147 is provided at a position where the shutter 147 faces the line head 40. The shutter 147 is then moved from the blocking position to the open position to expose the caps 71. The caps 71 are disposed in a storage 45a (see FIGS. 11C and 11D) formed in the head facing portion 45.

The caps 71 can cover the head chips 43 when the line head 40 is lowered in the state in which the shutter 147 is at the open position (see FIG. 11D). In this process, the caps 71 are slightly pushed down in the −Z direction against the pressing force of the springs 74, so that the elastic portions 71a come into close contact with the head surfaces 42a.

In a recording standby state in which the printer 1 is powered off or on, the controller 80 causes the caps 71 to cover the head chips 43 in the state in which the shutter 147, which will be described later, is at the open position. In addition, during flushing operation for preventing the nozzles 44 from clogging, the controller 80 causes the ink to be ejected toward the caps 71 in the state in which the shutter 147, which will be described later, is at the open position.

In addition, when recording data is received and recording is performed, the controller 80 raises the line head 40 to separate the head surfaces 42a from the caps 71, and moves the shutter 147, which will be described later, to the blocking position. The thus operating controller 80 prevents the conveyed medium from entering the storage 45a (see FIG. 11C) of the head facing portion 45, or the posture of the medium from being disturbed. In addition, entry of foreign matter such as paper dust into the caps 71 during the conveyance of the medium, and deterioration of the performance of the caps 71 are avoided.

The shutter 147 provided at the head facing portion 45 will next be described.

The head facing portion 45 includes an upstream support 146 and a downstream support 150, as shown in FIG. 9. The upstream support 146 is a support located upstream of the shutter 147 in the medium conveyance direction, and is an example of a support that supports the medium along with the shutter 147 located at the blocking position. The downstream support 150 is a support located downstream of the shutter 147 in the medium conveyance direction, and is an example of a support that supports the medium along with the shutter 147 located at the blocking position.

The shutter 147 is provided between the upstream support 146 and the downstream support 150 in the medium conveyance direction. The upstream support 146, the shutter 147, and the downstream support 150 are portions that support the medium.

Although will be described later in detail, the shutter 147 is movable along the medium conveyance direction. The upstream support 146 and the downstream support 150 are provided in a state in which they are fixed.

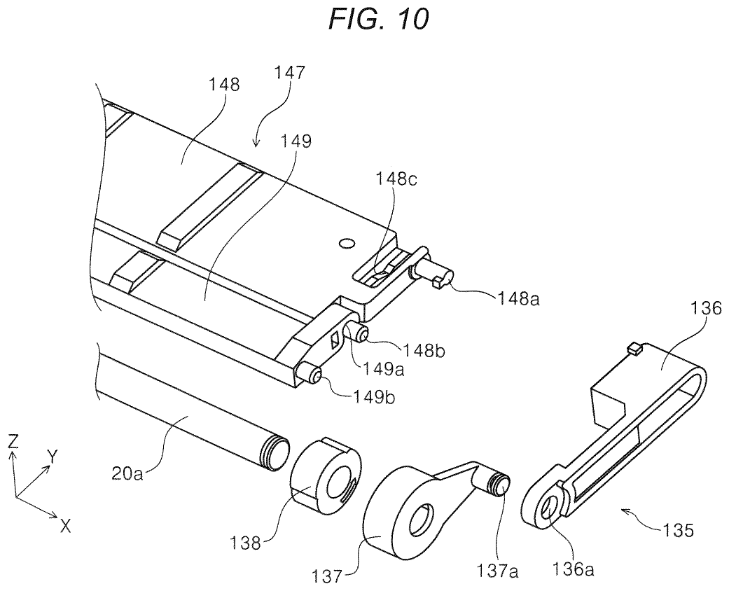

The shutter 147 includes a first moving portion 148 and a second moving portion 149. The first moving portion 148 and the second moving portion 149 are pivotably coupled to each other. FIG. 10 is an exploded perspective view showing the configuration of the shutter 147 in the +X direction. Note that the configuration of the shutter 147 in the −X direction is not shown, but is the same as the configuration shown in FIG. 10. Specifically, the configuration of the shutter 147 in the −X direction and the configuration of the shutter 147 in the +X direction are line-symmetric with respect to the Y axis at the center position of the shutter 147 in the X-axis direction.

The first moving portion 148 is provided with guided portions 148a and 148b protruding outward in the medium width direction. The guided portion 148b is located at a position shifted from the guided portion 148a in the −Y direction.

The second moving portion 149 is provided with a guided portion 149b protruding outward in the medium width direction.

An engagement hole 149a is formed in the second moving portion 149, and the guided portion 148b of the first moving portion 148 enters the engagement hole 149a, so that the first moving portion 148 and the second moving portion 149 are so linked to each other that the two moving portions make pivotal motion. Note that the pivotal motion described herein is pivotal motion in a Y-Z plane.

The head facing portion 45 includes guide members that are not shown but extend in the −X direction and the +X direction with respect to the shutter 147. The guide members each have a guide groove 130a (see FIGS. 11A to 11E), which guides the guided portions 148a and 148b of the first moving portion 148 and the guided portion 148b of the second moving portion 149 along the Y-axis direction.

The guide groove 130a includes a first groove portion 130b extending in parallel to the Y-axis direction, as shown in FIGS. 11A to 11E. The guide groove 130a further includes a second groove portion 130c located downstream of the first groove portion 130b in the medium conveyance direction and extending in a direction inclining with respect to the Y-axis direction. The guide groove 130a still further includes a third groove portion 130d located downstream of the second groove portion 130c in the medium conveyance direction and extending in parallel to the Y-axis direction.

A crank mechanism 135, which moves the shutter 147, will next be described.

In FIGS. 10 and 11A to 11E, the shutter 147 moves when receiving power from the rotary shaft 20a of the driving roller 20, which constitutes the second conveyance roller pair 19. The rotary shaft 20a rotates when receiving power from the driving roller 16, which constitutes the first conveyance roller pair 15, via a power transmission mechanism that is not shown.

The direction in which the rotary shaft 20a rotates when the second conveyance roller pair 19 conveys the medium downstream in the medium conveyance direction is referred to as a first rotation direction C1. A rotation direction opposite the first rotation direction C1 is referred to as a second rotation direction C2.

The crank mechanism 135 transmits the rotation of the rotary shaft 20a to the shutter 147 to move the shutter 147. The crank mechanism 135 is provided on opposite sides of the shutter 147 in the X-axis direction.

The crank mechanisms 135 each include a first arm 136, which is pivotably linked to the guided portion 148a, which is one of the multiple guided portions provided at a side portion of the shutter 147. The crank mechanisms 135 each further include a second arm 137, which is pivotably linked to the first arm 136 and is pivotable around the rotary shaft 20a. The crank mechanisms 135 still further each include a one-way clutch 138 interposed between the rotary shaft 20a and the second arm 137.

The first arm 136 has an engagement hole 36a. The second arm 137 has a boss 137a. When the boss 137a enters the engagement hole 36a, the first arm 136 and the second arm 137 are so linked to each other that the two arms make pivotal motion. Note that the pivotal motion described herein is pivotal motion in a Y-Z plane.

When the rotary shaft 20a rotates in the first rotation direction C1, the one-way clutch 138 does not transmit the rotation of the rotary shaft 20a to the second arm 137. When the rotary shaft 20a rotates in the second rotation direction C2, the one-way clutch 138 transmits the rotation of the rotary shaft 20a to the second arm 137.

When the rotary shaft 20a rotates in the second rotation direction C2, the second arm 137 and the rotary shaft 20a rotate as a unit. When the second arm 137 rotates, the first arm 136 moves along the Y-axis direction, and the first moving portion 148 that engages with the first arm 136, that is, the shutter 147 moves along the Y-axis direction.

When the rotary shaft 20a rotates in the first rotation direction C1, the rotation of the rotary shaft 20a is not transmitted to the second arm 137, so that the shutter 147 can maintain the stationary state, particularly, the blocking state when the medium is conveyed downstream.

FIG. 11A shows the state in which the shutter 147 is at the blocking position. In this state, the guided portions 148a, 148b, and 149b are located in the first groove portion 130b.

When the rotary shaft 20a rotates in the second rotation direction C2 from this state, the shutter 147 moves to the open position shown in FIG. 11C via the state shown in FIG. 11B. In the present embodiment, the open position of the shutter 147 is a position changed from the blocking position shown in FIG. 11A by the rotary shaft 20a rotating by 180° in the second rotation direction C2.

In the process of moving the shutter 147 from the blocking position to the open position, the guided portions 148b and 149b enter the third groove portion 130d via the second groove portion 130c. The guided portion 148a moves in the −Y direction in the first groove portion 130b.

When the shutter 147 moves from the blocking position to the open position, the caps 71 are exposed. When the line head 40 is lowered in this state and reaches the capped position, the caps 71 come into contact with the head surfaces 42a of the line head 40 and covers the head chips 43, as shown in FIG. 11D.

To move the shutter 147 in the state shown in FIG. 11D from the open position to the blocking position, the line head 40 is raised, and then the rotary shaft 20a is rotated in the second rotation direction C2. The shutter 147 thus moves to the blocking position shown in FIG. 11A via the state shown in FIG. 11E.

The shutter 147 includes multiple moving portions along the direction in which the shutter 147 moves, and two adjacent moving portions are pivotably linked to each other, as described above. Furthermore, when the shutter 147 is at the open position, at least one of the moving portions takes an inclining posture with respect to the head surfaces 42a. In the present embodiment, the first moving portion 148 takes an inclining posture with respect to the head surfaces 42a, as shown in FIG. 11C.

The space occupied by the shutter 147 in the direction parallel to the head surfaces 42a, that is, in the medium conveyance direction at the position where the shutter 147 faces the head surfaces 42a can thus be reduced. As a result, an increase in size of the printer 1 in the medium conveyance direction can be suppressed.

Note in the present embodiment that the multiple moving portions are configured with the first moving portion 148 and the second moving portion 149, but not necessarily, and may be configured with three or more moving portions.

Furthermore, in the present embodiment, when the shutter 147 is at the open position, the first moving portion 148 takes the inclining posture with respect to the head surfaces 42a, and the second moving portion 149 is parallel to the head surfaces 42a. Accordingly, as compared with a configuration in which the first moving portion 148 and the second moving portion 149 each take the inclining posture with respect to the head surfaces 42a, the space occupied by the shutter 147 in the Z-axis direction, that is, the direction of a normal to the head surfaces 42a can be suppressed.

However, in place of the first moving portion 148 or in addition to the first moving portion 148, the second moving portion 149 may take the inclining posture with respect to the head surfaces 42a.

The head facing portion 45 and the caps 71 will be subsequently further described.

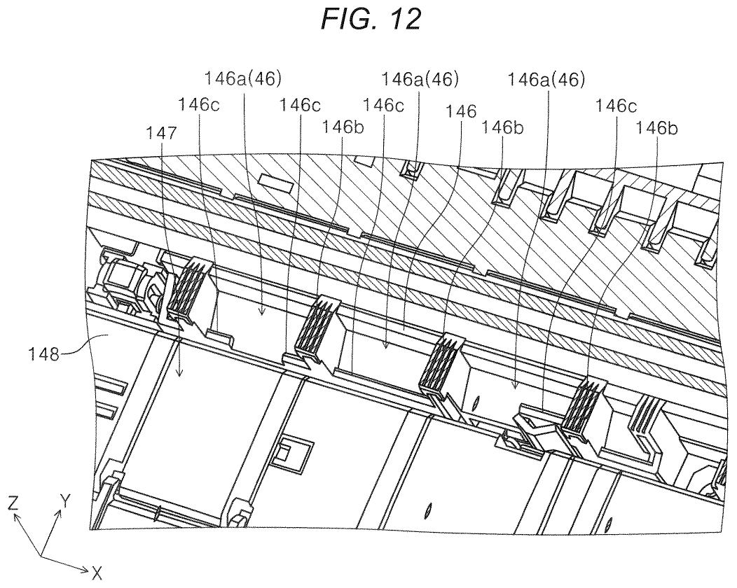

The upstream support 146, which constitutes the head facing portion 45, includes medium supports 146b as a portion that supports the medium, as shown in FIGS. 9 and 12. Multiple medium supports 146b are provided at appropriate intervals along the medium width direction. A recess 146a is formed between any two adjacent medium supports 146b.

The recesses 146a are each a recess provided not to interfere with the roller holder 50a and the pivotal motion support 50b described with reference to FIG. 5. That is, in the line head 40, the roller holder 50a and the pivotal motion support 50b are provided upstream of the head surfaces 42a in the medium conveyance direction. When the line head 40 is lowered from the recording position to the capped position, the roller holder 50a and the pivotal motion support 50b are at positions where they interfere with the upstream support 146, so that the upstream support 146 is provided with the recesses 146a, which are provided not to interfere with the roller holder 50a and the pivotal motion support 50b. The recesses 146a form a portion of an opening 46 (see FIG. 13) formed between the upstream end of the shutter 147 at the blocking position and the upstream support 146.

When the shutter 147 is at the blocking position, a gap G1 is provided between the upstream end of the shutter 147 and the upstream support 146 in the medium conveyance direction, as shown in FIG. 13. The gap G1 is provided along the detection line SL1 used by the edge detector 38 described with reference to FIG. 4. Since the edge detector 38 is an optical sensor, and it is necessary to suppress reflected light when there is no medium, the gap G1 functions as a reflection suppressor that suppresses reflection of detection light emitted from the edge detector 38. The gap G1 forms a portion of the opening 46 formed between the upstream end of the shutter 147 at the blocking position and the upstream support 146.

Note in the present embodiment that the opening 46 formed between the shutter 147 at the blocking position and the upstream support 146 is formed of the recesses 146a and the gap G1, and may instead be formed of only one of the recesses 146a and the gap G1.

When the opening 46 is formed between the shutter 147 at the blocking position and the upstream support 146 as described above, there is a concern that paper dust enters via the opening 46 and adheres to the caps 71. In FIG. 13, arrows e are an example of the direction in which the paper dust moves toward the caps 71. When the paper dust adheres to the caps 71, the adhesion between the caps 71 and the head surfaces 42a decreases, which may cause maintenance failure and lower the recording quality.

In the present embodiment, to suppress such a problem, walls 72a rising in the +Z direction are provided between the opening 46 and the caps 71 in the medium conveyance direction, as shown in FIG. 13. The +Z direction is an example of a first direction that is a direction from the base toward the tip of each of the caps 71. Therefore, even when paper dust enters via the opening 46, the walls 72a can suppress adhesion of the paper dust to the caps 71.

In the present embodiment, the top of each of the walls 72a is configured to be lower than the top of each of the caps 71. Therefore, when the caps 71 cover the head surfaces 42a, a situation in which the walls 72a come into contact with the head surfaces 42a can be avoided.

Furthermore, in the present embodiment, since the walls 72a are configured as a portion of the holding members 72, the walls 72a can be readily provided. Note, however, that the walls 72a may be configured separately from the holding members 72.

In the present embodiment, the opening 46 is formed between the upstream end of the shutter 147 in the medium conveyance direction and the upstream support 146. In the configuration described above, when the medium is conveyed downstream in the −Y direction, paper dust tends to enter the line head 40 via the opening 46, and the paper dust tends to adhere to the caps 71. The walls 72a can, however, suppress adhesion of the paper dust to the caps 71.

Note that the opening 46 may be formed between the downstream end of the shutter 147 in the medium conveyance direction and the downstream support 150.

In addition, the shutter 147 according to the present embodiment includes the first moving portion 148 and the second moving portion 149, and a gap G2 is provided between the first moving portion 148 and the second moving portion 149, as shown in FIG. 13. There is therefore a concern that paper dust entervia the gap G2 and adheres to the caps 71. In the present embodiment, however, since the walls 72a are also provided between the caps 71 and the gap G2 in the medium conveyance direction, adhesion of the paper dust to the caps 71 can be suppressed.

In the present embodiment, the recesses 146a form a portion of the opening 46. In the configuration in which the recesses 146a form a portion of the opening 46 as described above, paper dust tends to enter the line head 40 via the opening 46, but the walls 72a can suppress adhesion of the paper dust to the caps 71.

A rib 146c, which restricts movement of the paper dust to the caps 71, is provided at the bottom of each of the recesses 146a, as shown in FIGS. 12 and 13. Thea ribs 146c can prevent the paper dust having entered the recesses 146a from traveling toward the caps 71. The ribs 146c may be formed without a break or may have breaks along the medium width direction.

Furthermore, in the present embodiment, the gap G1, which functions as the reflection suppressor, forms a portion of the opening 46, as described above. In the configuration described above, paper dust tends to enter the line head 40 via the opening 46, and the paper dust tends to adhere to the caps 71. However, since the walls 72a are provided, adhesion of the paper dust to the caps 71 can be suppressed.

Note that the opening 46 may be formed between the shutter 147 and the downstream support 150 (see FIG. 9) in the medium conveyance direction. In this case, providing the walls 72a between the opening 46, which is formed between the shutter 147 and the downstream support 150 in the medium conveyance direction, and the caps 71 can prevent adhesion of the paper dust to the caps 71.

In this case, the gap G1, which functions as the reflection suppressor, may be formed between the downstream end of the shutter 147 and the downstream support 150.

In the present embodiment, the walls 72a are provided to surround the caps 71, as shown in FIG. 8. According to the configuration described above, the adhesion of the paper dust to the caps 71 can be further suppressed.

Furthermore, the ink can be accumulated inside the walls 72a. When the ink overflows from the caps 71, the configuration described above can prevent the overflowing ink from spreading over a wide range inside the printer 1 and contaminating the interior of the printer 1.

In addition, since the walls 72a improve the rigidity around the caps 71, the caps 71 can be uniformly brought into close contact with the head surfaces 42a, so that the basic function of the caps 71 can be satisfactorily provided.

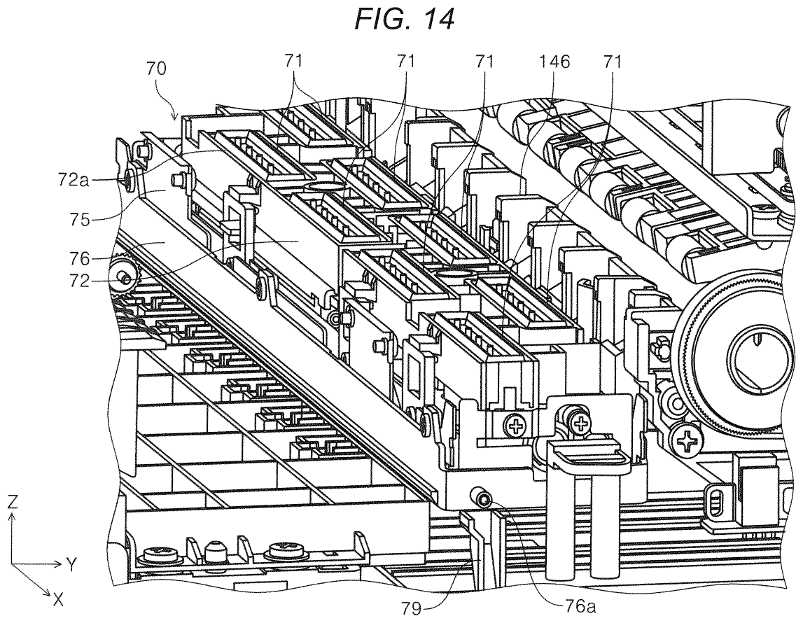

Note in the present embodiment that the base portion 76, which supports the caps 71, is provided with a discharge port 76a, via which the ink overflowing from the walls 72a is discharged, as shown in FIG. 14. When the ink overflows from the walls 72a, the discharge port 76a can prevent the overflowing ink from spreading over a wide range inside the printer 1 and contaminating the interior of the printer 1.

The ink discharged via the discharge port 76a is guided to a waste liquid accumulator that is not shown via a guide member 79.

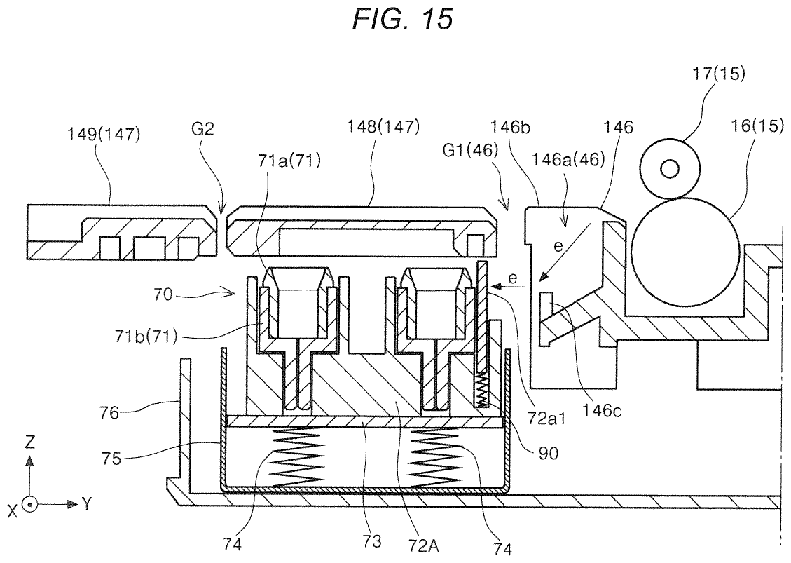

Another embodiment of the walls will next be described with reference to FIG. 15.

In FIG. 15, a wall 72a1 is provided to be displaceable in the +Z direction and the −Z direction in the holding member 72A. The −Z direction is an example of a second direction. The wall 72a1 is pressed in the +Z direction by a spring 90, which is an example of the pressing member. The displacement of the wall 72a1 in the +Z direction is restricted by a restrictor that is not shown but is provided at the holding member 72A. In the state in which the caps 71 are separate from the head surfaces 42a, the end in the +Z direction, that is, the upper end of the wall 72a1 is located at a position shifted in the +Z direction from the end in the +Z direction, that is, the upper end of each of the caps 71.

According to the configuration described above, adhesion of the paper dust to the caps 71 is effectively suppressed by the wall 72a1.

When the caps 71 are in contact with the head surfaces 42a, the wall 72a1 can be retracted in the −Z direction. The configuration described above can prevent the wall 72a1 from hindering the sealing of the head surfaces 42a by the caps 71.

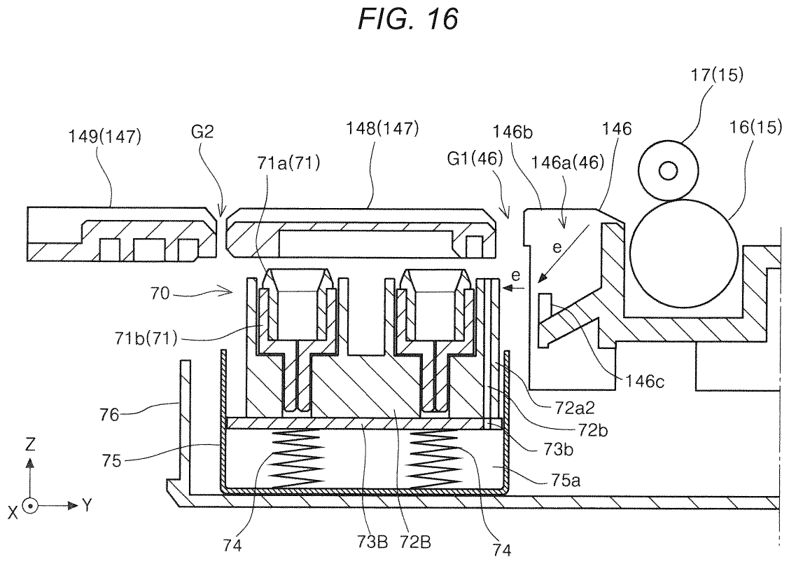

Another embodiment of the wall will next be described with reference to FIG. 16.

In FIG. 16, a suction hole 72b is formed in a wall 72a2. The suction hole 72b passes through the wall 72a2 in the Z-axis direction. A hole 73b is formed in a first support frame 73B at a position corresponding to the suction hole 72b. The suction hole 72b thus communicates with a space 75a below the first support frame 73B. A negative pressure can be provided in the space 75a by a pump that is not shown, so that paper the dust can be sucked through the suction hole 72b. The configuration described above can more effectively suppress adhesion of the paper dust to the caps 71.

The present disclosure is not limited to the embodiment and variations described above, but various variations can be made within the scope of the disclosure described in the claims, and it is obvious that the variations also fall within the scope of the present disclosure.

What is claimed is:

1. A liquid ejecting apparatus comprising:
a liquid ejecting head configured to perform recording by ejecting liquid onto a medium;
a cap configured to face a liquid ejecting surface of the liquid ejecting head;
a shutter configured to be displaceable to a blocking position at which the shutter covers the cap and an open position at which the shutter exposes the cap, the shutter at the blocking position configured to support the medium passing through a position where the medium faces the liquid ejecting head; and
a support located at least upstream or downstream of the shutter in a medium conveyance direction at a position where the medium faces the liquid ejecting head, the support configured to support the medium along with the shutter located at the blocking position,
wherein an opening is formed between the shutter located at the blocking position and the support, and
a wall rising in a first direction that is a direction from a base toward a tip of the cap is provided between the opening and the cap in the medium conveyance direction.

2. The liquid ejecting apparatus according to claim 1, wherein
the opening is formed between an upstream end of the shutter in the medium conveyance direction and the support located upstream of the shutter in the medium conveyance direction.

3. The liquid ejecting apparatus according to claim 2, further comprising:
at least one contact member integrated with the liquid ejecting head and configured to come into contact with the medium conveyed at a position where the medium faces the liquid ejecting surface; and
a holder configured to hold the contact member,
wherein the holder is located upstream of the liquid ejecting surface in the medium conveyance direction,
the liquid ejecting head is displaceable to
a recording position at which recording is performed on the medium, and
a capped position at which the liquid ejecting surface is covered by the cap,
a recess is formed in the support, the recess allowing the support not to interfere with the holder when the liquid ejecting head is located at the capped position, and
the recess forms a portion of the opening.

4. The liquid ejecting apparatus according to claim 3, further comprising
a rib provided at a bottom of the recess and configured to restrict movement of paper dust to the cap.

5. The liquid ejecting apparatus according to claim 2, further comprising
an edge detector configured to detect an edge of the medium by moving in a medium width direction that is a direction intersecting with the medium conveyance direction,
wherein the edge detector is an optical sensor,
a reflection suppressor configured to suppress reflection of detection light emitted from the edge detector is provided at a position where the reflection suppressor faces the edge detector,
the reflection suppressor is formed by a gap provided between the shutter at the blocking position and the support, and
the gap forms a portion of the opening.

6. The liquid ejecting apparatus according to claim 1, wherein
the wall is provided to surround the cap.

7. The liquid ejecting apparatus according to claim 6, further comprising
a base portion configured to support the cap,
wherein the base portion has a discharge port via which the liquid overflowing from the wall is discharged.

8. The liquid ejection apparatus according to claim 1, wherein
the cap is provided to be movable toward and away from the liquid ejection surface, and is pressed toward the liquid ejection surface.

9. The liquid ejecting apparatus according to claim 1, wherein
the wall is displaceable in the first direction and a second direction opposite the first direction, and is pressed in the first direction, and
in a state in which the cap is separate from the liquid ejecting surface, an end of the wall in the first direction is located in the first direction beyond an end of the cap in the first direction.

10. The liquid ejecting apparatus according to claim 1, wherein
the wall has a suction hole, and is configured to suction paper dust via the suction hole.
